(19) United States
(12) Patent Application Publication
(10) Pub. No.: US 2024/0393044 A1
(43) Pub. Date: Nov. 28, 2024

(54) METHOD FOR FROSTING CARBON DIOXIDE CONTAINED IN LIQUID METHANE

(71) Applicants: Denis CLODIC, Wissous (FR); Joseph TOUBASSY, Wissous (FR); Mauro RIVA, Wissous (FR)

(72) Inventors: Denis CLODIC, Wissous (FR); Joseph TOUBASSY, Wissous (FR); Mauro RIVA, Wissous (FR)

(21) Appl. No.: 18/696,016

(22) PCT Filed: Sep. 27, 2022
(86) PCT No.: PCT/IB2022/059164

§ 371 Date: Mar. 27, 2024

(51) Int. Cl. F25J 3/06

(52) U.S. Cl. CPC F25J 3/067; F25J 3/0615; F25J 2205/20; F25J 2205/84

(57) ABSTRACT

Method for extracting carbon dioxide in liquid methane, including expanding a liquid methane the carbon dioxide content being greater than 280 ppmv, the expansion carried out from a pressure greater than 6 bar to a pressure of 1 bar, the temperature of the liquid methane expanded being about −161.5° C., passing the methane gas phase and the carbon dioxide solid phase into a first liquid-solid-gas separator, with extraction of the solid carbon dioxide by filtration, and separation of the methane gas, to obtain a first liquid methane phase, partially decarbonized, transferring this first liquid methane phase to a second solid-liquid separator, the first liquid methane phase at −161° C., the second separator being an exchanger at less than −170° C., the carbon dioxide depositing in the second exchanger, to form a second liquid methane phase, the concentration of carbon dioxide in this second liquid methane phase at −170° C. being less than 200 ppmv.

### TECHNICAL FIELD

The invention relates to the extraction of carbon dioxide (CO₂) contained in liquid methane.

### STATE OF THE ART

Natural gas and biogas from biomass, i.e. from the fermentation of organic waste, largely contain methane with formula CH₄.

Natural gas mainly contains methane but also, in lower quantities, ethane (C₂H₆), propane (C₃H₈), butane (C₄H₁₂) as well as hydrogen sulphide (H₂S) and CO₂. Like natural gas, biogas contains hydrogen sulphide and CO₂.

Liquefaction of methane or natural gas requires cryogenic systems. The temperature of the gas is lowered to liquefaction temperatures below −160° C. at atmospheric pressure. In a natural gas liquefaction process, elements such as ethane, propane, butane, hydrogen sulphide and a large proportion of CO₂ are extracted and recycled for other uses. There is then only liquid methane containing CO₂ with relatively low contents, of about 3,000 parts per million in volume, so-called ppmv, but this purification is insufficient to obtain Liquefied Natural Gas (LNG) or liquefied methane at 1 bar and −161.5° C.

The method and the device object of the invention aim to reduce the CO₂ content of methane to very low values, from 50 to 100 ppmv, starting from typical concentrations of about 3,000 ppmv of CO₂ methane in liquid phase.

Methane brought to its liquefaction temperature at atmospheric pressure, i.e. −161.5° C., and containing CO₂ will be supersaturated with solid CO₂ if the CO₂ content is greater than 270 ppmv, as taught in the publication “Solid-liquid-vapour phase behaviour of the methane-carbon dioxide system” by J. A DAVIS, Newell RODEWALD and Fred KURATA in the AIChE JOURNAL volume 8, Issue 4, September 1962.

Supersaturation is indicated by the appearance of solid CO₂ which will clog valves or pipes, which is not acceptable.

This problem is known to specialists in the transport of liquid methane or LNG. The difference between liquid methane and liquefied natural gas is that the latter contains methane and heavier hydrocarbons, typically from C2 (ethane or ethylene) to C6 (hexane), up to contents of about 10% maximum, i.e. 90% methane and 10% other hydrocarbons. The presence of other hydrocarbons slightly improves the solubility of CO₂ in LNG, the lowest solubility is in fact that of CO₂ in pure methane.

The object of the invention is to guarantee a residual CO₂ content in liquid methane or LNG of less than 200 ppmv.

U.S. Pat. No. 3,254,496 describes a method of separating solid CO₂ and methane after expanding the methane.

US patent 2012/125043 describes a method of precipitation of CO₂ by a stream of liquid methane.

### INVENTION

A first object of the invention is a method for extracting carbon dioxide contained in liquid methane, the method comprising:
a step of expansion of a liquid methane the carbon dioxide content of which is greater than 280 parts per million by volume, and in particular of about 3000 parts per million by volume (ppmv), the expansion being carried out from a pressure greater than 6 bar to a pressure of 1 bar, the temperature of the liquid methane thus expanded being about −161.5° C., the methane vaporising and the carbon dioxide crystallising during this expansion, to form a three-phase liquid-vapour-solid mixture of methane and carbon dioxide, the resulting liquid methane being supersaturated with carbon dioxide, the method comprising:
a step of transitioning from the gas phase of methane and the solid phase of carbon dioxide in a first, liquid-solid-gas separator, with extraction of the solid carbon dioxide by filtering, and separation of the methane gas, to obtain a first, partially decarbonated, liquid methane phase,
   a step of transferring this first liquid methane phase to a second, solid-liquid separator, the first liquid methane phase being at a temperature of −161° C., the second separator being an exchanger the temperature of which is lower than −170° C., carbon dioxide being deposited in the second exchanger, to form a second liquid methane phase, the concentration of carbon dioxide in this second liquid methane phase at −170° C. being less than 200 ppmv, advantageously less than 100 ppmv.

According to various embodiments, the method according to the invention has the following characteristics, possibly combined.

The carbon dioxide content of the first liquid methane phase, from the first separator, is about 300 ppmv.

In some embodiments, the temperature of the second separator is −176° C., with the carbon dioxide content of the second phase of liquid methane, at the outlet of the second separator, being less than 50 ppmv.

In some embodiments, the method comprises a step of extracting the solid carbon dioxide deposited in the second separator, this extraction being carried out in the gas phase at a pressure of about 500 mbar.

In other embodiments, the method comprises a step of extracting the solid carbon dioxide deposited in the second separator, this extraction being carried out in liquid phase at a pressure of about 6 bar.

Advantageously, the method comprises a step of measuring the pressure loss on the liquid methane between the inlet and outlet of the first separator.

When the pressure loss on the liquid methane between the inlet and outlet of the first separator is greater than a predetermined threshold, the extraction of the carbon dioxide deposited in the first separator is interrupted.

Advantageously, the first separator comprises two enclosures, each enclosure being provided with a micron filter for recovery of the solid carbon dioxide.

When the extraction of the carbon dioxide deposited in the first separator is interrupted, the method comprises a step of heating the filters.

Advantageously, the method comprises a measurement of the temperature of the fluid circulating in the filters, downstream of the filters, the extraction of the carbon dioxide being completed when this temperature exceeds a predetermined threshold value, advantageously of about 10° C.

When the extraction of the carbon dioxide is interrupted, the methane flow is advantageously diverted from a first enclosure to the second enclosure of the first separator.

Advantageously, the method comprises a step of measuring the pressure loss on the liquid methane between the inlet and outlet of the second separator.

In some embodiments, the second separator is a finned-tube exchanger.

Advantageously, the maximum speed of the liquid methane in the channels formed by the inter-fin spaces of the second exchanger is about 0.2 m/s.

When the pressure loss on the liquid methane between the inlet and outlet of the second separator is greater than a predetermined threshold, the extraction of the carbon dioxide deposited in the second separator is interrupted.

In some advantageous embodiments, the second separator comprises two enclosures, the method comprises a step of heating an enclosure when the frosting of the carbon dioxide deposited in this enclosure of the second separator is interrupted.

Advantageously, the method comprises a measurement of the temperature of the fluid circulating in the enclosures, downstream of the enclosures, the defrosting of the carbon dioxide being completed when this temperature exceeds a predetermined threshold value.

When the frosting of the carbon dioxide is completed in a first enclosure of the second separator, the methane flow is advantageously diverted to the second enclosure of the second separator, the second separator thus operating alternately, one enclosure of the second separator being in the frosting phase when the other enclosure of the second separator is in the defrosting phase.

The invention relates, according to a second aspect, to a device for extracting the carbon dioxide contained in liquid methane, for implementing the method presented above, the device comprising:
a liquid methane tank with a carbon dioxide content of about 3,000 parts per million by volume (ppmv), at a pressure greater than 6 bar;
an expansion valve downstream of the tank, to reduce the pressure of the liquid methane to a value of 1 bar, the temperature of the liquid methane thus expanded being approximately −161.5° C., to form a three-phase liquid-vapour-solid mixture of methane and carbon dioxide, the liquid methane obtained being supersaturated with carbon dioxide;
a first liquid-solid-gas separator, wherein between the three-phase liquid-vapour-solid mixture, with extraction of the solid carbon dioxide by filtration, and separation of the gaseous methane, to obtain a first phase of liquid methane, partially decarbonized;
a second liquid-solid separator, wherein between the first phase of liquid methane at a temperature of −161° C., the second separator being an exchanger the temperature of which is less than −170° C., carbon dioxide being deposited in the second separator, to form a second phase of liquid methane, the concentration of carbon dioxide in this second phase of liquid methane at −170° C. being less than 100 ppmv.

Advantageously, the first separator comprises two enclosures, each enclosure being provided with a micron filter for recovery of the solid carbon dioxide.

Advantageously, the two enclosures of the first separator are identical.

In some embodiments, the micron filter has a solid matrix with a porosity of about 10 micrometres.

Advantageously, the second separator comprises two enclosures, each enclosure being provided with a finned-tube exchanger.

Several aspects of the method for extracting the CO₂ object of the invention will be presented in more detail.

The table below is taken from the publication “Solid-liquid-vapour phase behaviour of the methane-carbon dioxide system” by J. A DAVIS, Newell RODEWALD and Fred KURATA in AIChE JOURNAL volume 8, Issue 4, September 1962.

| | | | Saturating |
|---|---|---|---|
| | | Saturating volume | concentrations of |
| Pressure | Saturation | concentrations of | CO₂ |
| (bar | temperature | CO₂ | in liquid methane |
| absolute) | (° C.) | in the liquid methane | expressed in ppm v |
| 1.0 | −161.8 | 0.00027 | 270 |
| 1.6 | −156.6 | 0.00051 | 510 |
| 2.1 | −152.3 | 0.00083 | 830 |
| 3.0 | −147.1 | 0.0014 | 1400 |
| 3.6 | −143.6 | 0.0019 | 1900 |
| 4.3 | −140.8 | 0.0025 | 2500 |
| 6.4 | −133.6 | 0.0047 | 4700 |
| 7.9 | −129.2 | 0.0066 | 6600 |
| 9.8 | −124.6 | 0.0092 | 9200 |
| 11.4 | −121.3 | 0.016 | 10,600 |
| 15.4 | −113.7 | 0.019 | 10,900 |

This table was supplemented, to establish the solubility of the CO₂ in methane for temperatures below −161.5° C., based on the high-precision measurements presented in the thesis of Mauro Riva “Method of purification of biomethane: thermodynamic study of the solid-liquid-vapour balances of mixtures rich in methane” defended on Sep. 12, 2016 at the Ecole des Mines de Paris.

| P (bar) | 1 | 1 | 1 | 1 | 1 |
|---|---|---|---|---|---|
| T CH₄ liquid (° C.) | −161.5 | −163.5 | −166.5 | −171.5 | −176.5 |
| CO₂ | 279 | 216 | 144 | 69 | 31 |
| solubility (ppm v) | | | | | |

As the table based on the thesis of Mr Riva's shows, the saturating concentration of CO₂ is 279 ppmv in liquid methane at 1 bar and −161.5° C.

Consequently, crystals of dry ice appear in liquid methane as soon as the methane is subcooled at constant pressure, with the solubility limit of CO₂ in methane being 144 ppmv at −166.5° C. and 1 bar. Similarly, the solubility limit of CO₂ in methane at −171.5° C. and 1 bar is 69 ppmv.

The method according to the present invention particularly exploits this physical phenomenon.

The steps of the method are advantageously as follows: liquid methane at a pressure above 6 bar has a CO₂ content of about 3000 ppm, therefore CO₂ is perfectly soluble therein, according to the table by J. A Davis et al.

This liquid methane is expanded from this high pressure to 1 bar and −161.5° C., which is the saturation temperature at 1 bar.

During this expansion, methane vaporises and CO₂ crystallises.

The methane gas phase and the solid phase of CO₂ pass through a liquid-solid-gas separator where the solid CO₂ is extracted by filtration, the gaseous methane is separated from the liquid.

This gaseous methane is advantageously returned upstream of the liquefier to be liquefied again.

The liquid methane from this first separator will be additionally decarbonised in a second separator.

The first step of separating the vapour phase and the liquid phase of methane makes it possible to control a slow rate of circulation of this liquid phase.

Indeed, a two-phase liquid-vapour mixture inherently has a higher speed than a liquid phase alone, for the same constructive arrangement.

The vaporisation of about 20% of the liquid during expansion leads to a ratio between the volume of the gas phase and the liquid phase, known as the vacuum rate, greater than 95%.

Therefore, 95% of the flow volume is occupied by gas and 5% by liquid.

The flow is therefore easily turbulent, which is not desirable for solid-liquid separation. Advantageously, in the method, the liquid methane phase at about −161° C. is transferred into an enclosure where this liquid methane circulates at low speed over the fins of an exchanger the temperature of which is below −170° C.

Solid CO₂ settles on the fins and the concentration of the CO₂ in liquid methane at −170° C. gradually falls below 100 ppm.

It is therefore a solid-liquid separation.

Once the CO₂ deposit thickens, the pressure losses increase and the measurement of this pressure loss advantageously gives the signal to a PLC for the liquid methane to be directed into another identical enclosure where the same finned-tube exchanger is arranged.

According to various embodiments, the liquid methane of the enclosure where the solid CO₂ has accumulated on the fins is purged, then the enclosure is drawn to vacuum, the finned-tube exchanger rises in temperature by the internal circulation of a heat transfer fluid to a temperature above −50° C. if the CO₂ is extracted in liquid phase, or above-100° C. if the CO₂ is extracted in gas phase at a pressure of about 500 millibar absolute. CO₂ extraction is simplified by this method, as there is no need for a facility using solvents of all kinds.

In addition, there is no need to recycle any substrate.

Several aspects of a device according to the invention will now be presented, according to various embodiment.

The carbon dioxide (CO₂) extraction device by frosting in liquid methane with a CO₂ content of about 3000 ppm comprises a methane tank at a pressure greater than 6 bars which is advantageously downstream of a methane liquefaction device at a pressure greater than 6 bars.

Downstream of this tank and upstream of a first separation device, an expansion valve reduces the pressure of the liquid methane to 1 bar and −161.5° C.

The three-phase liquid-vapour-solid mixture of methane and CO₂ resulting from this expansion enters through the bottom of this first separation device where a first filtration of the solid phase of CO₂ is carried out in a solid matrix with a porosity of about 10 micrometres, and the separation of the gas and liquid phases of methane.

The methane gas phase containing about 7 ppm CO₂ will advantageously be recycled and liquefied again.

The liquid methane phase containing about 300 ppm CO₂ is transferred by a pump to the second separation device.

Advantageously, the first separation device comprises two identical enclosures for alternating operation of each enclosure: when the separation of the three phases is carried out in one, the solid CO₂ is sublimated in the other by the circulation of gaseous methane at atmospheric pressure from the methane discharged by a methane compressor, which is upstream of the liquefaction exchanger, this methane liquefier supplies the tank described above.

The gaseous methane at about 50° C. sublimates the CO₂ and this gas flow is recycled by the aforementioned methane compressor.

The combination of methane expansion and the first separation device increases the CO₂ content of liquid methane from 3000 ppm to about 300 ppm by filtration of the liquid, and separates the gas and liquid phases, one aspirated by the methane compressor, the other by a pump that transfers the liquid methane to the second separation device. The flow of liquid methane at atmospheric pressure and with a content of about 300 ppm circulates in one of the two enclosures of the second separation device.

Advantageously, each enclosure of the second separation device comprises a finned-tube exchanger, the methane circulating in the multiple parallel channels formed by the inter-fin spaces of this exchanger.

The maximum speed of liquid methane is preferably about 0.2 m/s to facilitate the deposit of solid CO₂ on the fins and to prevent any pulling off of the frost already formed. The surface temperature of the fins is gradually colder, typically from −165° C. to −170° C., these temperatures being perfectly adjustable.

The CO₂ content passes from about 300 ppm to less than 100 ppm, it is sufficient to lower the final temperature to −176° C. to obtain a CO₂ content below 50 ppm.

The methane purified as such is stored in a tank and is ready for transport.

The second frost separation device for CO₂ in the liquid methane phase preferably also works alternately: when one exchanger is in the frost phase, the other is in the defrost phase, the extraction of the CO₂ deposited on the fins may take place either in the gas phase or in the liquid phase.

The methane and CO₂ separation device to obtain a final CO₂ concentration in liquid methane of less than 100 ppm advantageously comprises:
a liquid methane tank at a pressure greater than 6 bars and with a CO₂ concentration of about 3000 ppmv;
an expansion valve, making it possible to reduce the pressure of liquid methane to 1 bar and −161.5° C. the expansion producing a three-phase liquid-vapour-solid mixture, the solid being CO₂;
a first separation device comprising: two identical enclosures each with a micron filter, a two-phase mixture inlet pipe and two outlet pipes, one in the gas phase aspirated by a biomethane compressor with an anti-drip device, the other in the liquid phase provided with an immersion tube to prevent vapour bubbles;
a set of pipes and valves allowing the passage of liquid methane from one enclosure to the other, as well as for the gaseous methane and liquid methane outlets, with in addition a rinsing system with methane in the gas phase at 50° C. to sublimate the solid CO₂;
two differential pressure gauges, to measure the pressure loss between the methane inlet after expansion and the transfer pump inlet. These measurements are transferred to a PLC which will trigger the opening and closing of the valves allowing the circulation of the liquid methane entering as well as gaseous and liquid methane exiting through one or the other of the enclosures;
a hot gaseous methane supply line at 50° C. and at atmospheric pressure;
two temperature sensors, which enable the sublimation cycle of the solid CO₂ trapped in the matrix of the filter to be stopped when the temperature of the exiting methane exceeds a threshold value, typically 10° C.

The separation of liquid methane and CO₂ by frosting and defrosting is preferably also carried out alternately in two identical enclosures each containing a finned-tube exchanger where the liquid methane circulates at low speed so that the CO₂ frosts on the fins.

In some applications, these exchangers are supplied with a coolant of which the lowest temperature is below −170° C. from a cryogenic system.

The methane and CO₂ separation device for obtaining a final CO₂ concentration in liquid methane of less than 100 ppm advantageously further comprises:
a set of pipes and valves allowing liquid methane to pass from one enclosure to the other, as well as for the outlet of purified liquid methane;
two differential pressure gauges, to measure the pressure loss on the liquid phase from the inlet of the exchanger to its outlet, in order to transfer this data to a PLC which will trigger the opening and closing of the valves allowing the circulation of liquid methane entering as well as liquid methane exiting through one or the other of the enclosures. The purified methane transfer circuit from the enclosures to the storage tank is advantageously provided with a pump and a flowmeter, in order to check the emptying of the liquid methane before triggering the defrosting phase.

In some embodiments, the coolant circuit producing the cooling power is connected to a heat transfer circuit, which makes it possible to increase the temperature of the defrosting heat exchanger from −170° C. to −45° C. during the defrosting phase, allowing the sublimation and extraction of CO₂ sublimated in gas phase by the vacuum pump or sublimation up to 5.2 bar, then liquefaction of the CO₂ above this pressure of the triple point of the CO₂.

The methane and CO₂ separation device for obtaining a final CO₂ concentration in liquid methane of less than 100 ppm advantageously further comprises:
a vacuum drawing circuit, to empty the enclosure in the defrosting cycle of its methane before sublimation of the CO₂ and possibly recovering the CO₂ during defrosting according to the chosen option of defrosting in gas phase or in liquid phase;
a gas phase CO₂ pressurisation circuit to transfer the liquid CO₂ from the defrost to a CO₂ storage tank;
two temperature sensors, at the outlet of the coolant and heat transfer circuit, to control the maintaining of temperatures below −170° C. in frosting mode and the end of defrosting temperatures above −45° C. in the liquid defrost mode of the CO₂ or above −100° C. but below −60° C. in gas defrost mode.

The complete device preferably comprises a central unit, capable of implementing the method as previously described.

Other objects and advantages of the invention will appear in light of the description of an embodiment, made hereinafter in reference to the appended figures.

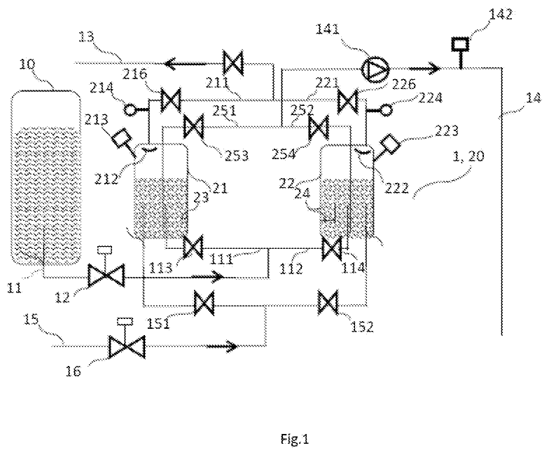

FIG. 1 is a schematic representation of a first separation device of a carbon dioxide extraction device from the liquid phase of methane;

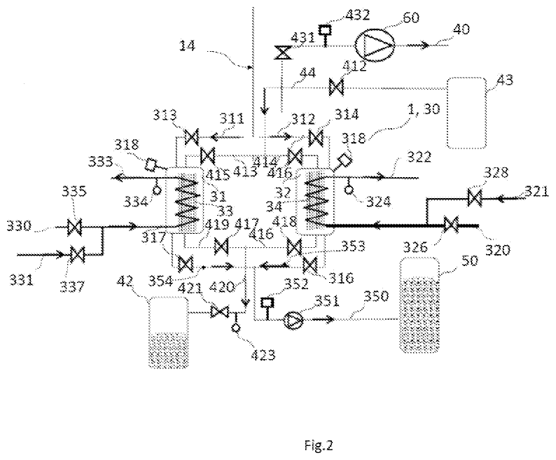

FIG. 2 is a schematic representation of a second separation device of a carbon dioxide extraction device from the liquid phase of methane.

The device 1 for filtering and frosting the CO₂ contained in liquid methane or LNG comprises a first separation device 20 shown schematically in FIG. 1, and a second separation device 30, shown in FIG. 2.

The methane leaving the first separation device 20 has a CO₂ content of about 300 ppm, and a pump 141 will circulate this methane in a line 14, to the second separation device 30.

Refer first to FIG. 1.

The device 1 comprises a liquid methane tank 10 at a pressure greater than 6 bar and the CO₂ concentration of which is about 3000 ppm.

The device 1 comprises an expansion valve 12 for reducing the pressure of the liquid methane to 1 bar, installed on a connecting pipe 11 between the tank 10 and two enclosures 21, 22 of the first separation device 20.

Each enclosure 21, 22 comprises a micron filter 23, 24.

Downstream of the expansion valve 12, the pipe 11 forms two branches 111, 112.

The enclosures 21, 22 are respectively supplied with liquid methane by the branches 111, 112 and solenoid valves 113, 114 control the supply to each of these enclosures 21, 22.

The solid CO₂ is recovered by the filters 23, 24.

The methane gas phase is discharged by a line 13 connected to the aspiration of a biomethane compressor, via a branch 211 for the enclosure 21 and a branch 221 for the enclosure 22.

A valve 216 and a temperature sensor 214 are placed on the branch 211.

Similarly, a valve 226 and a temperature sensor 224 are placed on the branch 221.

An anti-drip device 212 prevents the driving of droplets to the compressor, for the enclosure 21.

Similarly, an anti-drip device 222 prevents the driving of droplets to the compressor, for the enclosure 22.

The liquid methane is aspirated by a pump 141 installed on the line 14 that connects the first separator 20 to the second separator 30.

This pump 141 aspirates the liquid from a branch 251 for the enclosure 21, or from a branch 252 for the enclosure 22.

The liquid phase methane is extracted via a dip tube associated with each branch 251 and 252.

The line 14 is provided with a flowmeter 142, downstream of the pump 141.

The branch 251 is provided with a valve 253.

Similarly, the branch 252 is provided with a valve 254.

A line 15 supplies the enclosures 21, 22 with hot gaseous methane, at about 50° C. An expansion valve 16 is placed on this line 15, upstream of two supply branches of the enclosures 21, 22.

Each of the two supply branches of the hot gaseous methane enclosures is provided with a valve 151, 152.

The circulation of the methane flow is controlled by a PLC.

The PLC will open the series of valves 113, 216, 253 when methane is circulating in enclosure 21.

The PLC will open the series of valves 114, 226, 254 when methane is circulating in enclosure 22.

When one of these series of valves 113, 216, 253 is opened, the other series of valves 114, 226, 254 is closed.

The enclosure 21 is provided with a differential pressure gauge 213 measuring the pressure loss between the common inlet of the three-phase mixture and the liquid outlet on the branch 251, when the methane flow passes through the enclosure 21.

Similarly, the enclosure 22 is provided with a differential pressure gauge 223 measuring the pressure loss between the common inlet of the three-phase mixture and the liquid outlet on branch 252, when the methane flow passes through the enclosure 22.

When the separation is carried out in enclosure 21 and the high pressure loss threshold indicated by differential pressure gauge 213 is reached, then the PLC generates the following actions: switching of the methane flow from enclosure 21 to enclosure 22, by opening the series of valves 114, 226, 254 and closing valves 113, 216, the valve 253 remaining open so that pump 141 empties enclosure 21 of its liquid.

The valve 253 is closed again when the flowmeter 142 indicates a lower and constant flow value, the excess flow corresponding to the emptying of the volume of liquid extracted from the enclosure 21 which is known by construction.

Once the enclosure 21 has been emptied of its liquid, the PLC opens valves 216 and 151 and the expansion valve 16 installed on line 15, in order to circulate hot gaseous methane at about 50° C. to sublimate the CO₂ trapped in the filter 23.

The methane flow comes from the high pressure of the methane compressor, expanded by the expansion valve 16 and the rinsing flow of the filter 23 is mixed with the gaseous flow of branch 221 and these two flows are aspirated by the methane compressor, via the line 13.

When the outlet temperature of the enclosure 21 measured by the temperature sensor 214 reaches a temperature above 10° C., then the sublimation of the CO₂ trapped in the filter 23 is completed, and the PLC closes the expansion valve 16 and the valves 216 and 151.

The separator is ready for the three-phase separation of the next cycle.

The description of the purge of the filter 23 by sublimation of the CO₂ is identical for purge of the filter 24, with of course the opening and closing of valves corresponding to the valves of the enclosure 22.

The methane exiting from the first separation device 20 has a CO₂ content of about 300 ppm.

The pump 141 will circulate this methane in the second separation device 30, shown schematically in FIG. 2.

The second separation device 30 comprises two enclosures 31, 32. Each enclosure 31, 32 houses a finned-tube exchanger 33, 34.

The line 14 supplies the enclosure 31 via a branch 311, a valve 313 being arranged on this branch 311, upstream of the enclosure 31.

The line 14 supplies the enclosure 32 via a branch 312, a valve 314 being arranged on this branch 312, upstream of the enclosure 32.

The exchanger 33 of the enclosure 31 is supplied with coolant at −170° C. by a coolant line 330. A valve 335 is arranged on the line 330. A heat transfer circuit 331 is connected to the line 330 downstream of the valve 330. The heat-transfer circuit 331 is provided with a valve 337.

Similarly, the exchanger 34 of the enclosure 32 is supplied with coolant at −170° C. by a coolant line 320. A valve 326 is arranged on the line 320. A heat transfer circuit 321 is connected to the line 320 downstream of the valve 326. The heat transfer circuit 321 is equipped with a valve 328.

When the valve 335 of the coolant line 330 is open and the valve 337 of the heat transfer circuit 331 is closed, the exchanger 33 is supplied with coolant at −170° C. and the coolant exits the exchanger 33 via a line 333 to a cryogenic system (not shown), after cooling of the liquid methane in the exchanger 33.

A temperature sensor 334 is mounted on the line 333.

Similarly, when the valve 326 of the coolant line 320 is open and the valve 328 of the heat transfer circuit 321 is closed, the exchanger 34 is supplied with coolant at −170° C. and the coolant exits the exchanger 34 via a line 322 to a cryogenic system (not shown), after cooling of the liquid methane in the exchanger 34.

A temperature sensor 324 is mounted on the line 322.

The enclosures 31, 32 are connected to a liquid methane tank 50, by a line 350 on which a pump 351 and a flowmeter 352 are mounted. A valve 317 is downstream of the enclosure 31 and upstream of the tank 50, a valve 316 being downstream of the enclosure 32 and upstream of the tank 50.

The enclosures 31, 32 are connected to a pressurisation tank 43, by a line 44 whereon a valve 412 is mounted.

The line 44 is in communication with the enclosure 31 by a branch 413 whereon a valve 415 is mounted.

The line 44 is in communication with the enclosure 32 by a branch 414 whereon a valve 416 is mounted.

The enclosures 31, 32, are connected to a purge line 40 on which a vacuum pump 60, a dump valve 431 and a vacuum gauge 432 are mounted.

The enclosures 31, 32 are also connected to a liquid CO₂ recovery tank 42 by a line 420.

A valve 417 is mounted on the branch 419 of the line 420.

A valve 418 is mounted on the branch 416 of line 420.

Downstream of branches 416, 419, the line 420 is provided with a valve 421 and a temperature sensor 423.

The enclosures 31, 32 are each provided with a multifunctional pressure sensor 318, measuring the absolute pressure in each of the enclosures 31 and 32 and measuring the differential pressure between the pressure measured on the inlet branch 311 and the outlet branch 354 for the enclosure 31 and the inlet branch 312 and the outlet branch 353 for the enclosure 32.

If the frosting of the CO₂ is carried out in the enclosure 31, valves 313, 317 are opened and valve 314 is closed. The liquid methane circulating at low speed is cooled on the fins of the finned-tube exchanger 33 and the CO₂ frosts on the fins as the temperature on the exchanger 33 drops. The purified methane is aspirated by the pump 351 and stored in the tank 50.

Similarly, if the separation takes place in the enclosure 32, valves 314, 316 are opened and valve 313 is closed. The liquid methane circulating at low speed is cooled on the fins of the finned-tube exchanger 34 and the CO₂ frosts on the fins as the temperature on the exchanger 34 drops. Similarly, the purified methane is aspirated by the pump 351 and stored in the tank 50.

When the pressure difference measured by the sensor 318 between the inlet and outlet of the enclosure 31 or of the enclosure 32 is greater than a threshold of about 50 millibar, then the defrosting phase is launched. In the defrosting phase of the CO₂ exchanger 34 in vapour, the PLC performs the following actions: the valve 314 is closed, the pump 351 on the line 350 creates the additional vacuum that allows the enclosure 32 to be emptied of its purified liquid methane in the storage tank 50, the valve 316 is closed again when the flowmeter 352 indicates a lower and constant flow value, the excess flow corresponding to the emptying of the volume of liquid extracted from the enclosure 32 which is known by construction.

Then the valve 416 as well as the dump valve 431 are opened, the vacuum pump 60 of the vacuum line 40 is switched on and the residual atmosphere with residual vaporisation of liquid methane is carried out until the vacuum gauge 432 indicates a residual pressure of less than 1 mbar.

The coolant circuit 320 is closed by the valve 326 and the coolant circuit 321 is opened by the valve 328, the CO₂ pressure rises in the enclosure 32 and is maintained at about 500 mbar by the vacuum pump 60 until the temperature sensor 324 installed on the outlet line 322 of the coolant indicates a temperature above 10° C.

On the other hand, if liquid-phase defrosting is chosen, the dump valve 431 is closed, the vacuum pump 60 is stopped, defrosting is carried out in the same way by circulation of the heat transfer fluid in the exchanger and when the pressure inside the enclosure 32 measured by the pressure sensor 316 reaches 5.2 bar, triple point pressure, the CO₂ liquefies.

Similarly, the circulation of the coolant is stopped by closing the valve 328 when the temperature indicated by the measurement of sensor 324 of the circuit 322 is higher than 10° C.

The line 44 will connect, by opening valves 412, 416, the pressurisation tank 43 to about 8 bar and the enclosure 32.

The pressure in the enclosure 32 will increase from 5.2 bar to approximately 6 bar, pressure measured by the sensor 318, the PLC then opens the valves 418, 421 so that the liquid CO₂ is transferred to the CO₂ tank 42.

When the temperature sensor 423 indicates that the temperature rises from about −50° C. to a temperature above −45° C., this indicates the end of the CO₂ flow, the valves 421, 418 are closed as well as the valve 412, which isolates tanks 43, 42 again.

To purge the CO₂ vapour from the enclosure 32, the dump valve 431 is opened and it maintains a maximum pressure of 1.2 bar downstream to avoid a pressure surge at the vacuum pump 60 aspiration.

When the pressure reaches 1 mbar measured by the vacuum gauge 432, the vacuum pump 60 is stopped, the valves 431 and 414 are closed.

The enclosure 32 is ready to begin a new CO₂ frosting cycle in the liquid methane.

A first advantage of the method thus described is that it is not necessary to use solutions of all kinds to extract the CO₂. As a result, the device 1 is simplified.

A second advantage is that it is no longer necessary to recycle substrates of all kinds, which are obtained in conventional washing facilities.

1. A method for extracting carbon dioxide contained in liquid methane, the method comprising:
a step of expansion of a liquid methane the carbon dioxide content of which is greater than 280 parts per million by volume, and in particular about 3000 parts per million by volume, the expansion being carried out from a pressure greater than 6 bar to a pressure of 1 bar, the temperature of the liquid methane thus expanded being about −161.5° C., the methane vaporising and the carbon dioxide crystallising during this expansion, to form a three-phase liquid-vapour-solid mixture of methane and carbon dioxide, the resulting liquid methane being supersaturated with carbon dioxide, and
a step of passing the methane gas phase and the solid phase of carbon dioxide into a first liquid-solid-gas separator, with extraction of the solid carbon dioxide by filtration, and separation of the gaseous methane, to obtain a first liquid methane phase, partially decarbonized,
a step of transferring this first liquid methane phase to a second solid-liquid separator, the first liquid methane phase being at a temperature of −161° C., the second separator being an exchanger the temperature of which is less than −170° C., the carbon dioxide depositing in the second exchanger, to form a second liquid methane phase, the concentration of carbon dioxide in this second liquid methane phase at −170° C. being less than 200 ppmv,
advantageously below 100 ppmv.

2. The method according to claim 1, wherein the carbon dioxide content of the first liquid methane phase, from the first separator, is about 300 ppmv.

3. The method according to claim 1, wherein the temperature of the second separator is −176° C., the carbon dioxide content of the second liquid methane phase, at the outlet of the second separator, being less than 50 ppmv.

4. The method according to claim 1, comprising a step of extracting the solid carbon dioxide deposited in the second separator, this extraction being carried out in the gas phase at a pressure of about 500 mbar.

5. The method according to claim 1, comprising a step of extracting the solid carbon dioxide deposited in the second separator, this extraction being carried out in liquid phase at a pressure of about 6 bar.

6. The method according to claim 1, comprising a step of measuring the pressure loss on the liquid methane between the inlet and outlet of the first separator.

7. The method according to claim 6, wherein when the pressure loss on the liquid methane between the inlet and outlet of the first separator is greater than a predetermined threshold, the extraction of the carbon dioxide deposited in the first separator is interrupted.

8. The method according to claim 7, wherein the first separator comprises two enclosures, each enclosure being provided with a micron filter for recovery of solid carbon dioxide.

9. The method according to claim 8, wherein when the extraction of the carbon dioxide deposited in the first separator is interrupted, the method comprises a step of heating the filters.

10. The method according to claim 8, comprising a measurement of the temperature of the fluid circulating in the filters, downstream of the filters, the extraction of the carbon dioxide being completed when this temperature exceeds a predetermined threshold value, advantageously of about 10° C.

11. The method according to claim 8, wherein when the extraction of carbon dioxide is interrupted, the methane flow is diverted from a first enclosure to the second enclosure of the first separator.

12. The method according to claim 1, comprising a step of measuring the pressure loss on the liquid methane between the inlet and outlet of the second separator.

13. The method according to claim 12, wherein the second separator is a finned-tube exchanger.

14. The method according to claim 13, wherein the maximum speed of the liquid methane in the channels formed by the inter-fin spaces of the second exchanger is about 0.2 m/s.

15. The method according to claim 12, wherein when the pressure loss on the liquid methane between the inlet and outlet of the second separator is greater than a predetermined threshold, the extraction by frosting of the carbon dioxide deposited in the second separator is interrupted.

16. The method according to claim 12, wherein the second separator comprises two enclosures, the method comprises a step of heating an enclosure when the frosting of the carbon dioxide deposited in this enclosure of the second separator is interrupted.

17. The method according to claim 16, comprising a measurement of the temperature of the fluid circulating in the enclosures, downstream of the enclosures, the defrosting of the carbon dioxide being completed when this temperature exceeds a predetermined threshold value.

18. The method according to claim 17, wherein when the frosting of the carbon dioxide is completed in a first enclosure of the second separator, the methane flow is diverted to the second enclosure of the second separator, the second separator thus operating alternately, one enclosure of the second separator being in the frosting phase when the other enclosure of the second separator is in the defrosting phase.

19. A device for extracting the carbon dioxide contained in liquid methane, for implementing the method according to claim 1, the device comprising:
a tank of liquid methane the carbon dioxide content of which is about 3000 parts per million by volume, at a pressure greater than 6 bar;
an expansion valve downstream of the tank, to reduce the pressure of the liquid methane to a value of 1 bar, the temperature of the liquid methane thus expanded being about −161.5° C., to form a three-phase liquid-vapour-solid mixture of methane and carbon dioxide, the liquid methane obtained being supersaturated with carbon dioxide;
a first liquid-solid-gas separator, wherein between the three-phase liquid-vapour-solid mixture, with extraction of the solid carbon dioxide by filtration, and separation of the gaseous methane, to obtain a first phase of liquid methane, partially decarbonized;
a second liquid-solid separator, wherein between the first liquid methane phase at a temperature of −161° C., the second separator being an exchanger the temperature of which is less than −170° C., carbon dioxide depositing in the second separator, to form a second liquid methane phase, the concentration of carbon dioxide in this second phase of liquid methane at −170° C. being less than 100 ppmv.

20. The device according to claim 19, wherein the first separator comprises two enclosures, each enclosure being provided with a micron filter for recovery of solid carbon dioxide.

21. The device according to claim 20, wherein the two enclosures of the first separator are identical.

22. The device according to claim 20, wherein in that the micron filter has a solid matrix, with a porosity of about 10 micrometres.

23. The device according to claim 19, wherein the second separator comprises two enclosures, each enclosure being provided with a finned-tube exchanger.
